(19) United States
(12) Patent Application Publication
(10) Pub. No.: US 2013/0186205 A1
(43) Pub. Date: Jul. 25, 2013

(54) LIQUID PRESSURE SENSING STRUCTURE

(71) Applicant: Shen-Mu Kao, Taoyuan County (TW)

(72) Inventor: Shen-Mu Kao, Taoyuan County (TW)

(21) Appl. No.: 13/743,351

(22) Filed: Jan. 17, 2013

(30) Foreign Application Priority Data
Jan. 20, 2012 (TW) 101102332

(51) Int. Cl. G01L 7/08

(52) U.S. Cl. CPC G01L 7/08
USPC 73/715

(57) ABSTRACT

A liquid pressure sensing structure includes an air pressure sensing member to sense liquid, such as oil or water. A transferring unit is fitted on a sensing end of the air pressure sensing member. The transferring unit includes a diaphragm therein. The diaphragm divides the inside of the transferring unit into a first space and a second space. The first space communicates with the sensing end of the pressure sensing member and is in a seal state. An oil or water pressure source communicates with the second space of the transferring unit. The pressure is able to influence the position of the diaphragm to change the pressure of the first space so that the air pressure sensing member will get the pressure value. The present invention uses the cost-effective air pressure sensing member to sense the pressure of oil or water so as to control and lower the cost.

### BACKGROUND OF THE INVENTION

1. Field of the Invention

The present invention relates to a liquid pressure sensing structure, and more particularly to a liquid pressure sensing structure which comprises a cost-effective air pressure sensing member to sense oil or water.

2. Description of the Prior Art

A pressure sensor is widely used to many apparatuses or a pipe system. The type of pressure includes air pressure, water pressure, oil pressure or other liquid pressure. A conventional electronic pressure sensor has a sensing end. A pressure source is inputted to the sensing end. A pressure sensing member is able to output the pressure value through a signal output end when sensing the pressure. The pressure sensing member used to sense air pressure is cheap. The pressure sensing member used to sense oil or water pressure is expensive because it must have the capacity for anti-corrosion and can prevent limescale and incrustation. The price of the liquid sensing member is more than ten times than that of the air pressure sensing member. In view of the price difference between the air pressure sensing member and the liquid pressure sensing member, the inventor of the present invention has devoted himself based on his many years of practical experiences to solve these problems by using an air pressure sensing member to sense oil or water so as to lower the cost.

### SUMMARY OF THE INVENTION

The primary object of the present invention is to provide a liquid pressure sensing structure which comprises a cost-effective air pressure sensing member to sense liquid, such as oil, water or the like, so as to control and lower the cost.

In order to achieve the aforesaid object by using the air pressure sensing member to sense oil or water, the present invention comprises a transferring unit fitted on a sensing end of the air pressure sensing member. Thus, the transferring unit is able to transfer the liquid pressure to air pressure so as to achieve the aforesaid object.

The transferring unit has a hollow inside. The transferring unit comprises a diaphragm therein. The diaphragm divides the inside of the transferring unit into a lower first space and an upper second space. The first space communicates with the sensing end of the pressure sensing member and is in a seal state. An oil or water pressure source communicates with the second space of the transferring unit. The pressure will influence the position of the diaphragm to change the pressure of the first space so that the air pressure sensing member will get the pressure value.

Preferably, in another embodiment, the transferring unit comprises an inner body, an outer body, a diaphragm and a connecting body. The inner body has a hollow inside, and the top and bottom of the inner body are open. The inner body has a first space therein and a stepped inner stop ring formed on an inner wall thereof. The inner stop ring cooperates with an inner ring and an inner washer. The inner body further has a stepped outer stop ring formed on outer wall thereof. The outer body has a hollow inside, and the top and bottom are of the outer body open. The outer body is fitted on the inner body. The outer body has a second space therein and a stepped annular portion formed on an inner wall thereof. The annular portion cooperates with an outer ring and an outer washer. The diaphragm is levelly disposed close to the top of the inner body and the edge of the diaphragm is sealedly connected to the inner body. The connecting body has a reverse U cross-section. The top of the connecting body has an opening, and the bottom the connecting body has two engaging plates.

Preferably, the connection unit and the pressure sensing member are disposed in a casing.

Preferably, the diaphragm is disposed close to the top of the inner body and integrally formed with inner body by injection molding. That is to say, the edge of the diaphragm is first embedded in the inner body, and then the inner body with the diaphragm is formed by one-step molding.

Preferably, the diaphragm is disposed close to the top of the inner body, and the edge of the diaphragm is connected to the inner body by ultrasonic machining.

Preferably, the diaphragm is disposed close to the top of the inner body, and the edge of the diaphragm is connected to the inner body by threads.

### BRIEF DESCRIPTION OF THE DRAWINGS

FIG. 1 is an exploded and partial sectional view of a first embodiment of the present invention;

FIG. 2 is a sectional view of the first embodiment of the present invention in an operating state;

FIG. 3 is an exploded view of a second embodiment of the present invention;

FIG. 4 is a perspective view of the second embodiment of the present invention;

FIG. 5 is a sectional view of the second embodiment of the present invention in an operating state;

FIG. 6 is a sectional view showing the diaphragm connected by ultrasonic machining of the present invention;

FIG. 7 is a sectional view showing the connection way of the diaphragm of the present invention; and

FIG. 8 is a sectional view showing another connection way of the diaphragm of the present invention.

### DETAILED DESCRIPTION OF THE PREFERRED EMBODIMENTS

Embodiments of the present invention will now be described, by way of example only, with reference to the accompanying drawings.

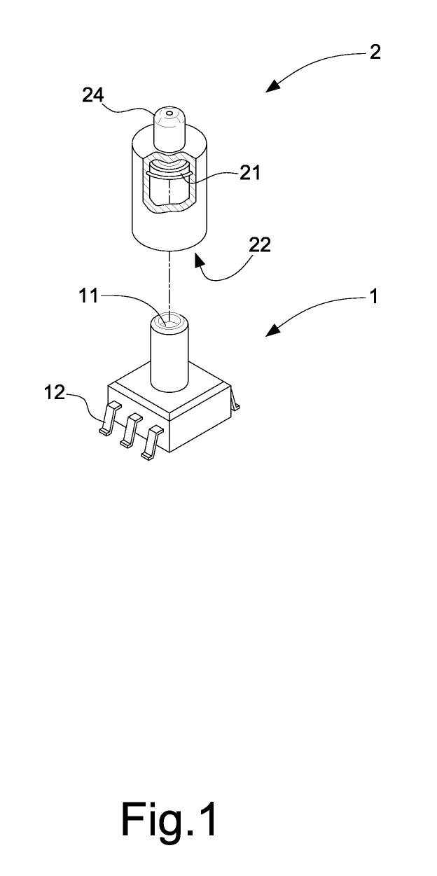

As shown in FIG. 1, a liquid pressure sensing structure of the present invention comprises a pressure sensing member 1 and a transferring unit 2. The pressure sensing member 1 is a sensing member to sense air. The pressure sensing member 1 comprises a sensing end 11 to input air pressure and a plurality of signal output ends 12. The transferring unit 2 has a hollow inside. The transferring unit 2 comprises a diaphragm 21 therein. The edge of the diaphragm 21 is embedded in the transferring unit 2. The diaphragm 21 is levelly disposed in the transferring unit 2 to divide the inside of the transferring unit 2 into a lower first space 21 and an upper second space 23. The first space 21 communicates with the sensing end 11 of the pressure sensing member 1 and is in a seal state. That is to say, the bottom of the transferring unit 2 is connected to the pressure sensing member 1 in any manner to be one-piece. The second space 23 communicates with an input end 24 at the top of the transferring unit 2.

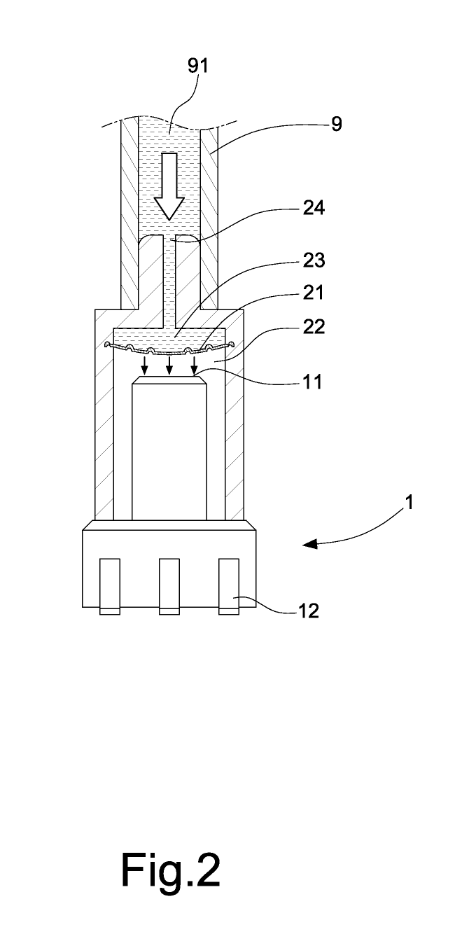

As shown in FIG. 2, when liquid 91, such as oil or water, is inputted from the input end 24 of the transferring unit 2 through a pipe 9, the liquid 91 (oil or water) has pressure to push the diaphragm 21 downward. The diaphragm 21 is deformed to result in that the air pressure value in the first space 22 is changed. The pressure sensing member 1 outputs the pressure value through the signal output ends 12.

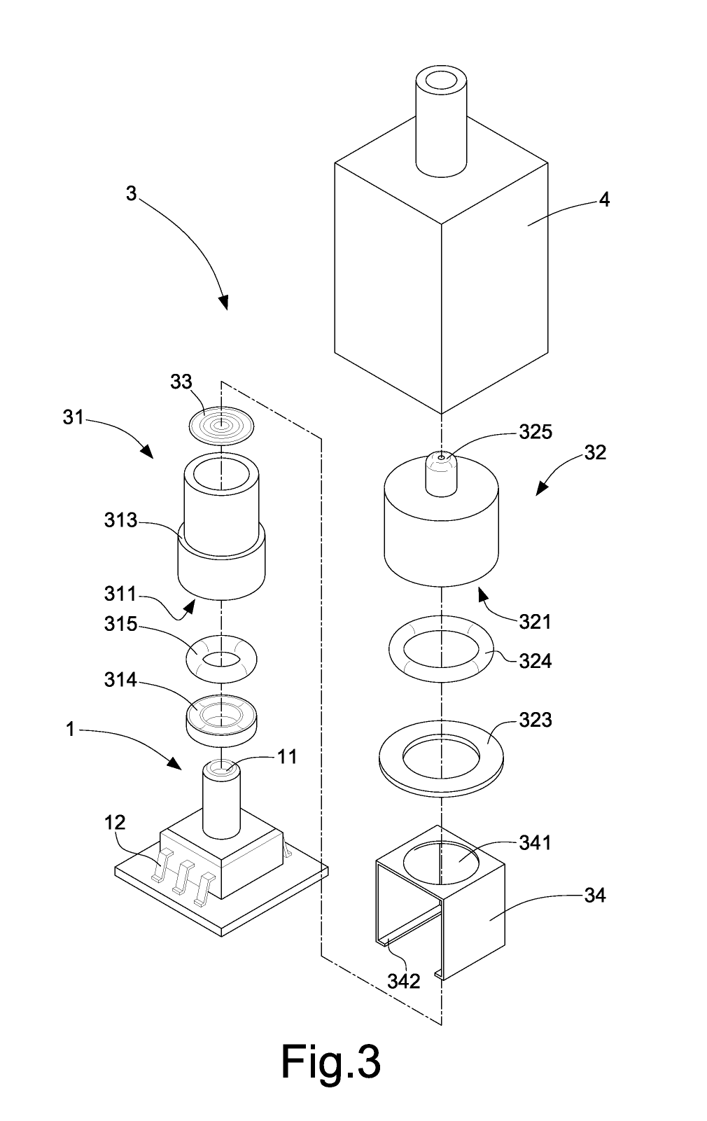

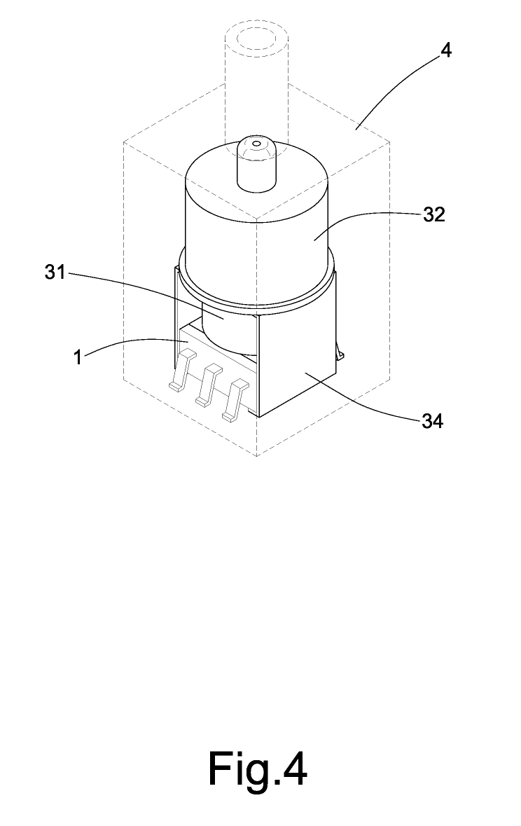

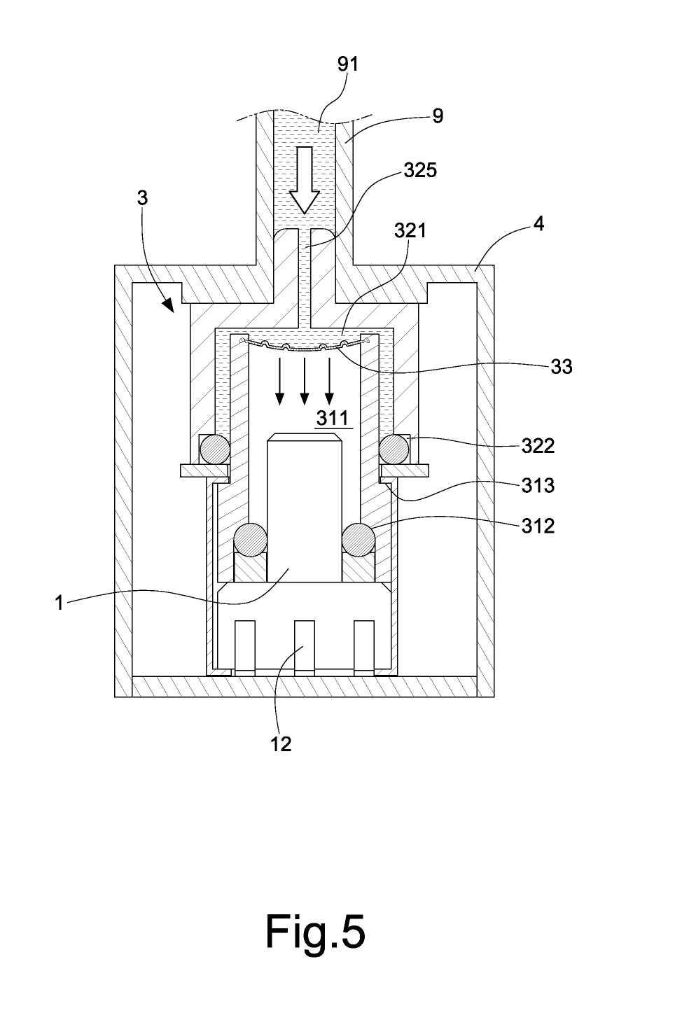

FIG. 3, FIG. 4 and FIG. 5 show another embodiment of the present invention. A transferring unit 3 comprises an inner body 31, an outer body 32, a diaphragm 33 and a connecting body 34. The inner body 31 has a hollow inside, and the top and bottom of the inner body 31 are open. The inner body 31 has a first space 311 therein and a stepped inner stop ring 312 formed on an inner wall thereof. The inner stop ring 312 cooperates with an inner ring 314 and an inner washer 315. The inner body 31 has a stepped outer stop ring 313 formed on outer wall thereof. The outer body 32 has a hollow inside, and the top and bottom of the outer body 32 are open. The outer body 32 is fitted on the inner body 31. The outer body 32 has a second space 321 therein and a stepped annular portion 322 formed on an inner wall thereof. The annular portion 332 cooperates with an outer ring 323 and an outer washer 324. The outer body 32 has an input end 325 at a top thereof. The diaphragm 33 is levelly disposed close to the top of the inner body 31 and the edge of the diaphragm 33 is sealedly connected to the inner body 31. The connecting body 34 has a reverse U cross-section. The top of the connecting body 34 has an opening 341, and the bottom the connecting body 34 has two engaging plates 342.

To assemble the present invention, the inner ring 314 and the inner washer 315 are coupled to the inner stop ring 312, and then the inner body 31 is fitted on the sensing end 11 of the pressure sensing member 1. The opening 341 of the connecting body 34 is fitted on the outer stop ring 313 of the inner body 31. The two engaging plates 342 of the connecting body 34 engage with two sides of the bottom of the pressure sensing member 1 so that the inner body 31 and the pressure sensing member 1 are connected to ensure that the first space 311 inside the inner body 31 is in a seal state. The outer ring 323 and the outer washer 324 are coupled to the annular portion 322, and then the outer body 32 is fitted on the top of the connecting body 34. Finally, the outer body 32 and the connecting body 34 are connected in any manner. For example, a casing 4 is used to cover the transferring unit 3.

As shown in FIG. 5, the liquid 91, such as oil or water, is inputted from the input end 325 of the transferring unit 3 through a pipe 9 to enter the second space 321. The liquid 91 (oil or water) has pressure to push the diaphragm 33. The diaphragm 33 is deformed toward the first space 311 to result in that the air pressure value in the first space 311 is changed. The pressure sensing member 1 outputs the pressure value through the signal output end 12.

In the aforesaid embodiment, the diaphragm 33 is disposed close to the top of the inner body 31 and integrally formed with inner body 31 by injection molding. That is to say, the edge of the diaphragm 33 is first embedded in the inner body 31, and then the inner body 31 with the diaphragm 33 is formed by one-step molding.

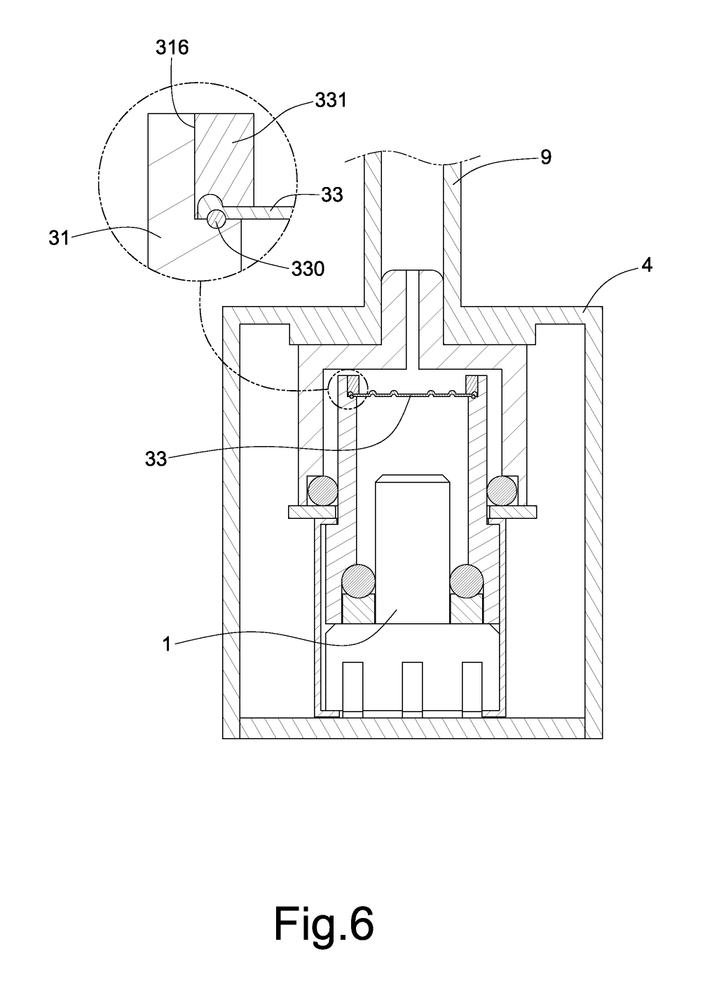

FIG. 6 shows another connection way of the diaphragm 33 and the inner body 31. The diaphragm 33 is disposed close to the top of the inner body 31, and the edge of the diaphragm 33 is connected to the inner body 31 by ultrasonic machining The top edge of the inner body 31 has a recessed ring 316. The top of the diaphragm 33 is provided with a connecting ring 331, and the edge of the bottom of the diaphragm 33 is provided with a washer 330.

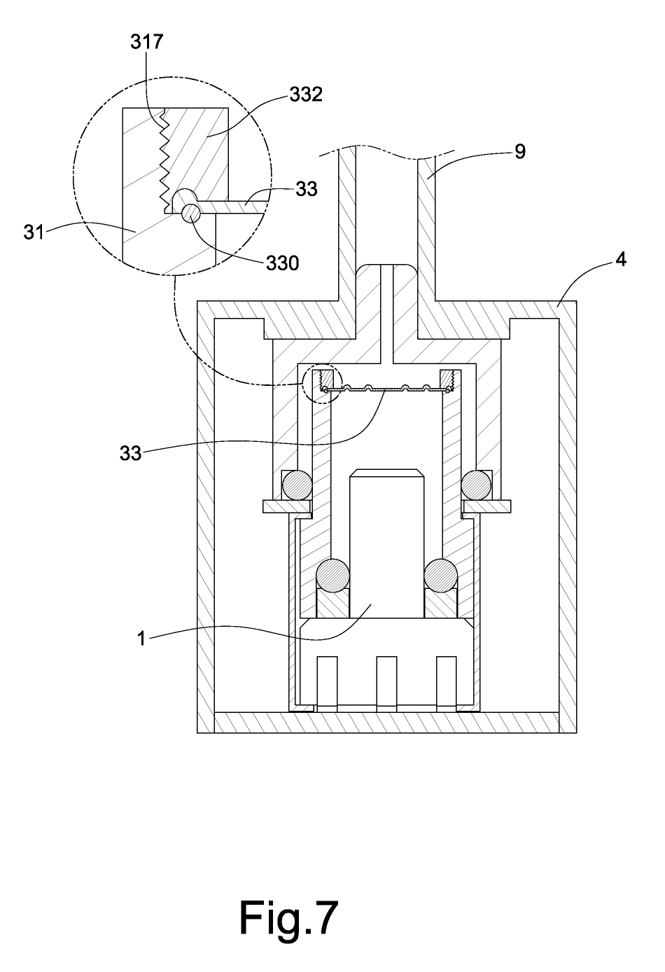

FIG. 7 shows another connection way of the diaphragm 33 and the inner body 31. The diaphragm 33 is disposed close to the top of the inner body 31, and the edge of the diaphragm 33 is connected to the inner body 31 by threads. The top edge of the inner body 31 has inner threads 317. The top of the diaphragm 33 is provided with an outer threaded member 332, and the edge of the bottom of the diaphragm 33 is provided with a washer 330. The diaphragm 33 is threadedly connected to the inner body 31.

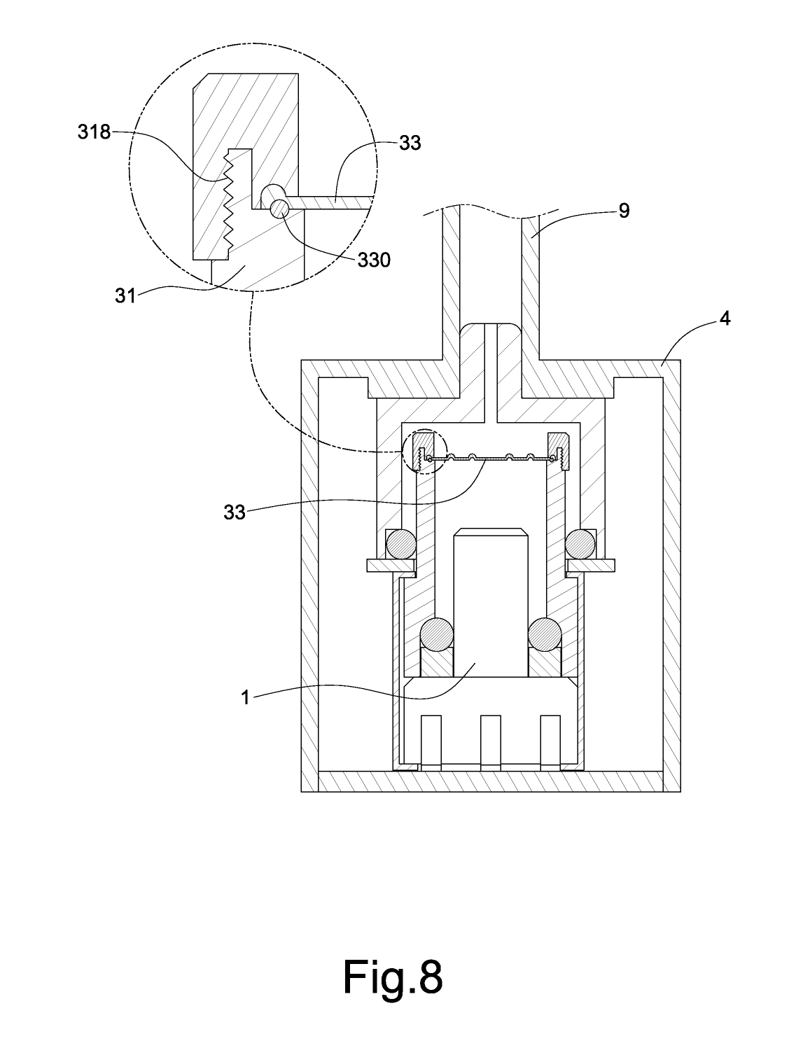

FIG. 8 shows another connection way of the diaphragm 33 and the inner body 31. The diaphragm 33 is disposed close to the top of the inner body 31, and the edge of the diaphragm 33 is connected to the inner body 31 by threads. The top edge of the inner body 31 has outer threads 318. The edge of the bottom of the diaphragm 33 is provided with a washer 330. The diaphragm 33 is threadedly connected to the inner body 31.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A liquid pressure sensing structure, comprising:
a pressure sensing member, the pressure sensing member being a sensing member to sense air, the pressure sensing member comprising a sensing end and a signal output end;
an inner body, the inner body having a hollow inside, the inner body having a first space therein, the first space communicating with the sensing end of the pressure sensing member and being in a seal state;
an outer body, the outer body having a hollow inside, the outer body being fitted on the inner body, the outer body having a second space therein, the outer body having an input end at a top thereof; and
a diaphragm, the diaphragm being sealed connected in the inner body, the first space and the second space are separated by the diaphragm.

2. The liquid pressure sensing structure as claimed in claim 1, wherein the inner body has a stepped inner stop ring formed on an inner wall thereof, the inner stop ring cooperating with an inner ring and an inner washer, the inner body further having a stepped outer stop ring formed on outer wall thereof.

3. The liquid pressure sensing structure as claimed in claim 2, wherein the outer body has a stepped annular portion formed on an inner wall thereof, the annular portion cooperating with an outer ring and an outer washer.

4. The liquid pressure sensing structure as claimed in claim 1, wherein the diaphragm is levelly disposed close to the top of the inner body and the edge of the diaphragm is sealed connected to the inner body in a seal manner.

5. The liquid pressure sensing structure as claimed in claim 2, further comprising a connecting body, the connecting body having a reverse U cross-section, the top of the connecting body having an opening, the bottom the connecting body having two engaging plates, the opening of the connecting body being fitted on the outer stop ring of the inner body, the two engaging plates of the connecting body engaging with two sides of the bottom of the pressure sensing member.

6. The liquid pressure sensing structure as claimed in claim 5, wherein the outer body and the connecting body are covered with a casing.

7. The liquid pressure sensing structure as claimed in claim 1, wherein the diaphragm is disposed close to the top of the inner body and integrally formed with inner body by injection molding.
